(19) United States
(12) Patent Application Publication
(10) Pub. No.: US 2023/0256845 A1
(43) Pub. Date: Aug. 17, 2023

(54) FULLY ENCLOSED SECURE EV CHARGING SYSTEM

(71) Applicant: The StressCrete Group, Burlington (CA)

(72) Inventors: Luke A. van Vliet, St. Catharines (CA); Michael R. Pearse, Fergus (CA)

(73) Assignee: The StressCrete Group, Burlington (CA)

(21) Appl. No.: 17/673,229

(22) Filed: Feb. 16, 2022

(51) Int. Cl. B60L 53/31; B60L 53/30; B60L 53/68

(52) U.S. Cl. CPC B60L 53/31; B60L 53/305; B60L 53/68; B60L 53/18

(57) ABSTRACT

An EV charging system includes an enclosure and an EV charger disposed therein. The enclosure includes a frame having four frame rails, a top bracket and a bottom bracket, upper and lower covers supported in the frame, a front panel supported in the frame and having an opening with an access for accessing an interior portion of the enclosure, a component box supported in the frame, and a hanger assembly for mounting the enclosure to a preexisting structure. The charger includes an EV charging unit, a connector accessible through the access door of the front panel, a cable for delivering charging current from the EV charging unit to the connector, and a cable retraction mechanism for retracting the cable into the interior. The access door is prevented from opening unless proper credentials are presented.

### TECHNICAL FIELD

The present disclosure relates generally to electrical vehicle charging stations.

### BACKGROUND

As electric vehicles gain acceptance, the number of charging stations required to service them increases rapidly. Easy access to charging power is critical to preserving driver confidence and reducing “range anxiety” in this emerging clean alternative transportation technology. The required easy access mandates wide distribution of charging stations, despite varying levels of security from one location to another. Many locations are unattended and public or semi-public, with little or no security some or all of the time. This leaves the charging stations, with their delicate and expensive equipment, vulnerable to theft and vandalism, which can disable the charging stations or compromise their safety. There are thus economic and societal needs for protecting charging stations, in order to maintain the integrity of the charging network and bolster the confidence of drivers as they adopt this promising new technology.

### OVERVIEW

Described herein is a secure charging system configured as a self-contained apparatus which includes an electric vehicle charging unit, as well as an EV charging cable retraction system, all within a rugged housing which allows for easy operation and access for vehicle charging, while providing environmental protection and protection from vandalism.

The core of the system is a Type 2 vehicle charging unit supplying 30 amps at 240 volts input. The EV unit is activated using a client card or online application. User input is done through a touch screen on the front of the charger unit in certain embodiments.

Upon successful activation of the unit a front mounted access door is unlocked allowing for user access to the J1772 connector and EV charging cable. The cable and connector are pulled outwards from the unit where it interacts with the vehicle to be charged. Upon completion of the charging the charge cable and connector are retracted into the unit via an internally mounted, spring tensioned reel system. Once the cable is retracted and the connector placed back in its cradle, the access door can be closed, ending the charging process, whereupon the access door is automatically locked.

The housing for the system is composed of rugged aluminum extrusions and heavy gauge steel brackets and aluminum panels. In certain embodiments, the housing itself has a NEMA 3R rating.

The EV charger may be mounted within the housing. The retraction reel is designed for an outdoor environment and specifically for the use of EV Type 2 systems.

Input power is provided through service feed wiring, typically from the mounting pole, and fed into the unit via electrical conduit. The input power wires are isolated from the other internal components and fed directly to the electrical housing where they are connected directly to a high current terminal block. From there power is directed through a high power relay contactor which allows for main power cut off via an externally mounted key switch. Power from the contactor is then fed via 10 gauge power cable to the charger unit. Output power from the charge unit is then fed via a 3×10 AWG, 1×18 AWG EVE cable to a 4-pole terminal block in the electrical compartment, on to the input of the retraction reel. The retraction reel holds 22′ of the same EVE 3×10 AWG+1×18 AWG cable at the end of which is a J1772 Type 2 charging connector.

The unit mounts to an existing pole, column, or wall via a rugged mounting hanger assembly and may be available in left side mount, right side mount, or back side mount configurations.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1. Shows a front view of the system 100 as intended to be installed on an existing pole or column.

FIG. 2. Shows a back view of the system 100 as intended to be installed on an existing pole or column.

FIG. 3. Shows one embodiment with a plurality of interchangeable mounting options including Left and Right Side Mount (left mount shown), or Rear Mount.

FIG. 4. Shows a side view including the mounting assembly 132 intended for mounting the system to an existing pole or column.

FIG. 5. Shows another side view of the mounting assembly 132 which can adapt to a multitude of existing pole/column cross-section shapes.

FIG. 6. Shows a back view of the system with the electrical cover 122 removed.

FIG. 7 Shows a more detailed view of the back of the system with the electrical cover removed.

FIG. 8. Shows an exploded front view of the system indicating the method of construction and component location.

FIG. 9. Shows an exploded back view of the system indicating the method of construction and component location.

FIG. 10. Shows a detail of the wiring schematic for the system in accordance with certain embodiments.

### DESCRIPTION OF EXAMPLE EMBODIMENTS

Example embodiments are described herein in the context of a fully enclosed secure charging system. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

In the description of example embodiments that follows, references to “one embodiment”, “an embodiment”, “an example embodiment”, “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

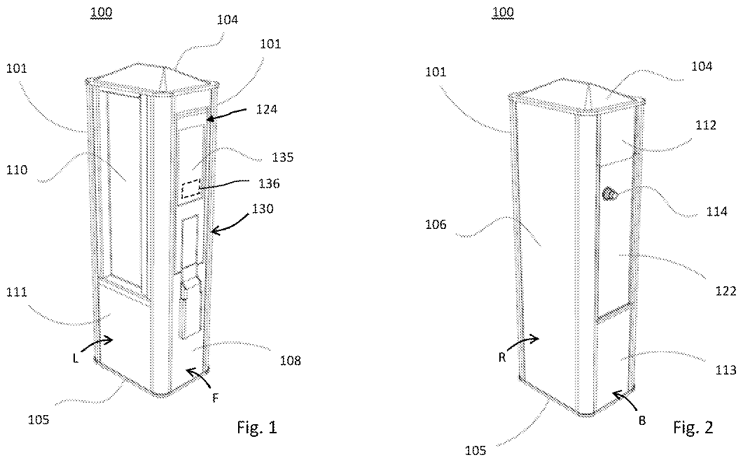

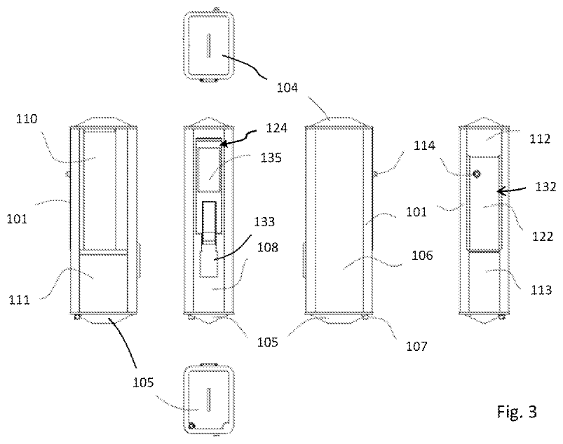

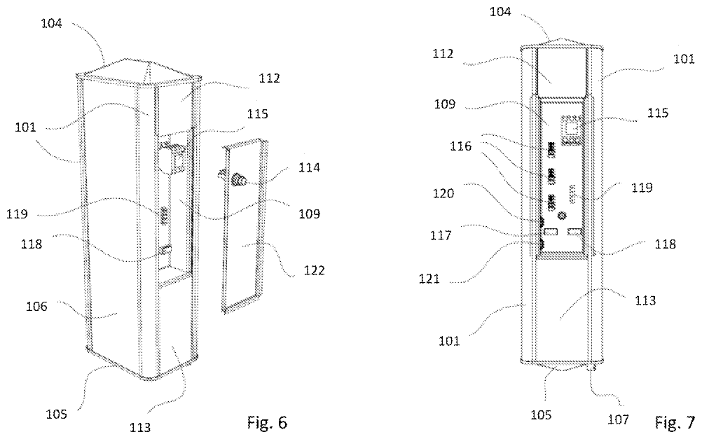

FIGS. 1-9 are various views of a fully-enclosed EV (electric vehicle) charging system 100 in accordance with certain embodiments. The charging system 100 has a generally rectangular cuboid parallelepiped shape, as seen in the perspective views of FIGS. 1 and 2, and in the example discussed has a left-side mount configuration, as detailed below. It will be appreciated that other shapes and other side mount configurations, such as right-side mount, or back-side mount, are also contemplated. In certain embodiments the individual components are interchangeable such that for example a kit containing the parts of the system 100 can be assembled for either left-side mount our right-side mount using the same components with little or no additional components required.

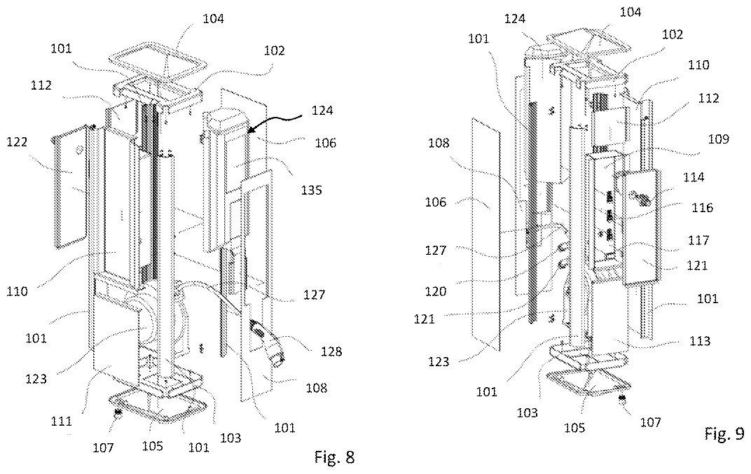

A frame comprised of four frame rails 101, an upper support bracket 102, and a lower support bracket 103 (FIGS. 8-9), defines an enclosure 130 for housing an EV charger including an EV charging unit 124 and other components as detailed herein below. The frame supports top and bottom covers 104 and 105 respectively. In certain embodiments, the frame rails 101 are made of extruded aluminum. They, along with the upper and lower support brackets 102 and 103, which can be made of heavy gauge steel, provide the primary structural support for the charging system. In certain embodiments, top and bottom covers 104 and 105 are made of aluminum.

A front side F of enclosure 130 includes a front panel 108, and a right side R includes hanger panel 110 and lower hanger panel 111. A left side L includes full side panel 106, and a back side B includes a component electrical box cover 122 and upper and lower back panels 112 and 113, respectively. In certain embodiments, front panel 108, lower hanger panel 111, and upper and lower back panels 112 and 113 are made of heavy gauge aluminum, whereas hanger panel 111, which is part of a hanger assembly described below, may be made of heavy gauge steel. Some or all of the panels, as well and the electrical box cover, may be coated, for example with a polyester powder coating (not shown).

As seen in the exploded view of FIG. 8, enclosure 130 houses in an interior region thereof the EV charger including the EV charging unit and other components. In use, when proper credentials are presented, the EV charger becomes accessible to a user for delivery of electric power to the user's vehicle (not shown). An EV charge connector 128 is adapted to couple to the electric vehicle to deliver the electric power by way of an electric cable 127, which may be a 22 foot long EVE 30 amp 600 volt 3-10 AWG cable. In certain embodiments, the connector 128 is a J1772 Type 2 EV Charger Connector which the user electrically plugs into the vehicle for charging. For efficient stowage, the cable 127, or portions thereof, may be wound around a cable retraction reel 123, which may be equipped with brushes or scrapers (not shown) to keep the cable clean and free of debris. The retraction reel 123 may be lockable to prevent unauthorized use, and may be automatically unlocked to permit unreeling of the cable 127 when proper credentials are presented to the charging unit 124, as detailed further below. Other lockable cable retraction mechanisms are also contemplated.

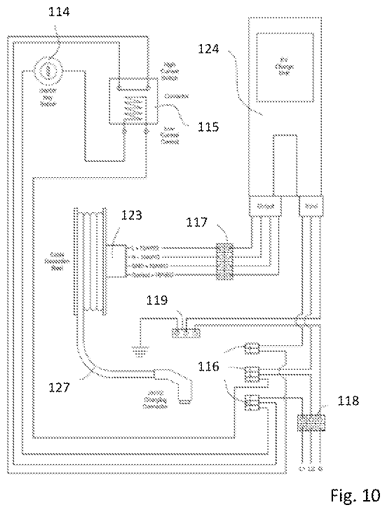

Enclosure 130 also houses in the interior region thereof component electrical box 109, sealable by cover 122, which may be of heavy gauge aluminum affording protection from the elements to the components within the box. Cover 122 may be retained in place substantially flush with the side on which the component electrical 109 is mounted (in this example, the back side B) with tamper-proof screws (not shown), to also protect against vandalism or theft. Electrical component box 109 contains other components of the electrical circuit of system 100, shown schematically in FIG. 10. Among these components is a system power contactor 115, which may be a high power relay for providing or cutting off service feed power to the system. A safety cutoff switch 114 is coupled to the system power contactor 115 to turn power on or off, and may be key activated. Electrical box 109 also houses multi-terminal, high current wire connectors 116, for example WAGO™ connectors, designed to act as a safe power bus for connecting multiple wires in the circuit. Electrical box 109 also houses a first terminal block 117, which may be a high current, 4-pole terminal strip for connecting the EV charging 124 unit output power to the cable 127, and a second terminal block 118, which may be a high current, 3-pole terminal strip for connecting an input service feed, provided through an electrical conduit connector to the EV charging unit. A high power, aluminum grounding block 119 serves to ground the frame and systems to earth. A first power conduit connector 120 provides for secure electrical connection between the component electrical box 109 and the charging unit output, and a second power conduit connector 121 provides for secure electrical connection between the component electrical box and retraction reel 123 input.

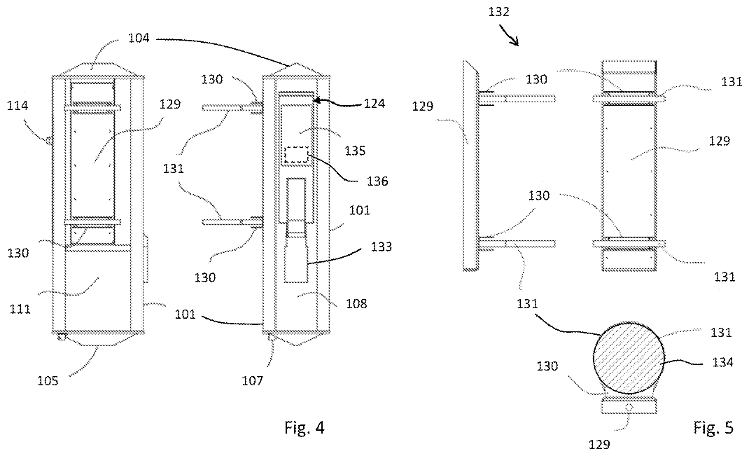

With reference to FIGS. 4 and 5, a hanger assembly 132 is provided to attach the system 100 to a structure 134, which may be a pre-existing pole or column or the like. Hanger assembly 132 includes hanger plate 129, which may be made of polyester powder coated heavy gauge steel. Hanger plate 129 securely mates, for example with tamper-proof screws or other fasteners (not shown) with hanger panel 110 disposed in left side L of system 100 and serves to secure the system 100 to the structure 134. A pair of pole-mounting brackets 130 of formed steel are secured to the hanger plate 129 and may be contoured to conform to the shape of the structure 134, for example circular, to optimize attachment to the structure. High strength stainless steel banding 131 is configured to wrap around the structure 134 to fully secure the system 100 to the structure. The number of brackets 130 and bands 131 may be differ from the two that are shown by way of example only.

In certain embodiments, EV charging unit 124 comprises a Type 2 EV charge unit providing 30 Amp capability at 240 volt AC input. EV charging unit 124 can have a user interface 135 such as an input panel or touch screen or keyboard or the like that are in alignment with an opening in panel 108 to provide access thereto. EV charging unit 124 may be activated via the user interface 135, or via subscription using a client card or wifi/Bluetooth connection, for presenting proper user credentials, without which charging services and physical access to system components are prevented. For instance, until proper credentials are presented, an access door 133 in front panel may be locked closed, so that the cable 127 and/or connector 128 cannot be reached. In certain embodiments the access door 133 may extend to further cover the user interface 135 that is in alignment with an opening in front panel 108. The extension of door 133 in this manner provides additional protection against vandalism. Alternatively or in addition, the retraction reel 123 may be locked, and the EV charge unit inactivated and unable to deliver charging power even if the cable and connector are accessed unless proper credentials are presented. An input device 136 such as a keyboard or wireless reader can be provided for receiving the proper user credentials, or these can be entered through the user interface 135. Input device 136 may be an integral part of the EV charge unit 124, or it may be a component distinct therefrom and mounted at a different location in the system 100 from the EV charge unit. In certain embodiments, it may be mounted at a location different from system 100 and in wired or wireless communication with the system. More generally, any input device, such as a user laptop or desk computer or smart phone or wireless reader disposed at or remote from the system 100 and in some instances in communication through a network that may include the Internet, may be used to enter the proper credentials of the user to gain access to the system. Once such access is gained, all necessary EV charging actions are enabled, including unlocking of retraction reel 123, activation of EV charging unit 124, and opening of any locked doors such as door 133 to provide access to the cable 127 and connector 128 and enable the user to electrically connect the system 100 to a vehicle for charging. Upon completion of charging, the charging unit 124 is again deactivated, the retraction reel is activated, through spring biasing action for instance, to retract the cable 127 and withdraw the connector 128 back inside the enclosure 130, and the door 133 is closed and locked so that the system is again secure and protected against theft and vandalism and the elements.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted based on the foregoing description. This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. An electric vehicle (EV) charging system for mounting to a pre-existing structure, comprising:
an enclosure defining an interior portion and including:
a frame having four frame rails, a top bracket and a bottom bracket, the frame defining front, rear, right, left, top and bottom sides of the enclosure,
upper and lower covers supported in the frame,
a front panel supported in the frame at the front side of the enclosure, the front panel having an opening and having an access door providing selective access to the interior portion of the enclosure,
an electrical component box supported in the frame at one of the rear, right, or left sides of the enclosure, and
a hanger assembly supported in the frame at another of the rear, right, or left sides of the enclosure, the hanger assembly including a hanger panel and a hanger that is fixedly attachable to the pre-existing structure and that is configured to mate with the hanger panel to thereby mount the enclosure on the pre-existing structure; and
an EV charger disposed in the interior portion of the enclosure and including:
an EV charging unit having a user interface aligned with the opening of the front panel,
a connector accessible through the access door of the front panel,
a cable for delivering charging current from the EV charging unit to the connector, and
a cable retraction mechanism for retracting the cable into the interior portion of the enclosure,
wherein the access door is prevented from opening and providing access to the connector and cable unless proper credentials are presented.

2. The electric vehicle (EV) charging system of claim 1, further comprising an input device for receiving the proper credentials.

3. The electric vehicle (EV) charging system of claim 2, wherein the input device is a keyboard disposed at one of the front, rear, right, left sides.

4. The electric vehicle (EV) charging system of claim 2, wherein the input device is a wireless reader disposed at one of the front, rear, right, left sides.

5. The electric vehicle (EV) charging system of claim 2, wherein the input device is a wireless reader disposed at a different location from the EV charging system.

6. The electric vehicle (EV) charging system of claim 2, wherein the input device is a computing device disposed remotely from the EV charging system.

7. The electric vehicle (EV) charging system of claim 1, wherein the hanger assembly includes one or more straps for fixedly attaching the hanger and mated hanger panel to the pre-existing structure to thereby mount the enclosure on the pre-existing structure.

8. The electric vehicle (EV) charging system of claim 1, further comprising a safety cut-off switch disposed at one of the front, rear, right, left, top and bottom sides for turning off power to the EV charging system.

9. The electric vehicle (EV) charging system of claim 8, wherein the safety cut-off switch is key-activated.

10. The electric vehicle (EV) charging system of claim 1, wherein the electrical component box extends into the interior portion of the enclosure and includes a cover disposed substantially at said one of the rear, right, or left sides of the enclosure.

11. The electric vehicle (EV) charging system of claim 10, wherein the electrical component box includes a box interior for housing electrical components selected from one or more of:
multi-terminal high current wire connectors,
a high current, 4-pole terminal strip for connecting EV charging unit output power to the cable,
a high current, 3-pole terminal strip for connecting an input service feed to the EV charging unit, and
a high power, aluminum grounding block to ground the EV charging to earth

12. The electric vehicle (EV) charging system of claim 1, wherein the access door is prevented from opening and providing access to the user interface unless proper credentials are presented.

13. The electric vehicle (EV) charging system of claim 1, wherein the cable retraction mechanism is locked to prevent unreeling of the cable unless proper credential are presented.
